(19) United States
(12) Patent Application Publication
(10) Pub. No.: US 2012/0177911 A1
(43) Pub. Date: Jul. 12, 2012

(54) PREPREG

(76) Inventors: Yasuyuki Kimura, Chiyoda-ku (JP); Yoshinori Gondoh, Chiyoda-ku (JP); Shinichiro Tachibana, Chiyoda-ku (JP)

(21) Appl. No.: 13/496,062

(22) PCT Filed: Sep. 14, 2010
(86) PCT No.: PCT/JP2010/065843

§ 371 Date: Mar. 14, 2012

(30) Foreign Application Priority Data
Sep. 15, 2009 (JP) 2009-213491

(51) Int. Cl. B32B 5/16

(52) U.S. Cl. 428/323

(57) ABSTRACT

There is provided a prepreg for electronic materials which has superior flame retardancy and heat resistance. The prepreg relevant to the present invention comprises a glass composition filler which has a mean particle diameter of 2.0 μm or less and a CaO content of 5% by mass or more, a glass cloth, and a matrix resin, characterized in that an amount of said glass composition filler to be filled is 10% by volume to 70% by volume relative to the total volume of said glass composition filler and said matrix resin.

### TECHNICAL FIELD

The present invention relates to a prepreg fox electronic materials comprising a glass composition filler, a glass cloth, and a matrix resin. In more detail, the present invention relates to a prepreg comprising a glass composition filler, having a mean particle diameter of 2.0 μm or less and a CaO content is 5% toy mass or more, a glass cloth, and a matrix resin, characterized in that a content of said glass composition filler in said prepreg is 10% by volume to 70% by volume.

### BACKGROUND ART

As an insulating material for printed wiring board for electronic devices, a prepreg comprising a thermosetting resin (hereinafter, also referred to as “matrix resin”) such as an epoxy resin, an inorganic filler agent (hereinafter, also referred to as “inorganic filler”), and a glass cloth has been widely used. A laminated sheet can be obtained by piling up multiple sheets of this prepreg and curing and molding under heated and pressurized conditions.

At present, high, density printed wiring board has progressed with shift to mobile and digitalization of electronic devices, and more superior heat resistance insulation reliability and stiffness than before have been required. In recent years, in particular, requirements of thinning and higher stiffness for wiring board has been intensified, and hence products in which an inorganic filler has been filled in a matrix resin to enhance stiffness have been developed.

In addition, a requirement for a product which has less environmental load has been grown, and hence a product using an inorganic filler, phosphorus type flame retardant and a combination thereof has become a main stream as a material which does not contain a conventional halogen type flame retardant.

The inorganic filler includes silica, alumina, aluminum hydroxide, magnesium hydroxide, talcum, mica, antimony oxide, calcium carbonate, titanium oxide, and the like. In particular, silica has been widely used in a printed wiring board from the viewpoints of heat resistance, insulation reliability and flame retardancy. In fact, a number of examples of prepregs or laminated sheets in which silica filler or aluminum hydroxide is applied, have been reported (see Patent Document 1 below).

On the other hand, when silica is highly filled in a matrix resin, although stiffness of wiring board is improved, a problem occurs that workability is significantly, deteriorated. For this problem, a prepreg having a superior workability in which a glass composition filler having an E glass composition is filled has been proposed (see Patent Document 2 below). In addition, as a method for producing a glass composition filler, a method in which a glass fiber is embrittled and then subjected to dry grinding has been proposed (see Patent Document 3 below). However, a glass cloth cannot be impregnated with said glass composition filler by using the particle diameter and the particle diameter distribution etc. of the glass composition filler by the conventional art, and it is difficult to obtain a wiring board having sufficient flame retardancy.

### PRIOR ART DOCUMENTS

### Patent Documents

Patent Document 1: JP-A-2009-155398
Patent Document 2: JP-A-2008-222986
Patent Document 3: JP-A-2003-192387

### SUMMARY OF INVENTION

### Problem to be Solved by the Invention

A problem to be solved by the present invention is to provide a prepreg for electronic materials which are superior in flame retardancy and heat resistance.

### Means for Solving the Problem

The present inventors have intensively studied and repeated experiments to solve the above-described problem, and found that a laminated sheet prepared from a prepreg in which a glass composition filler having a mean particle diameter of 2.0 μm or less and a CaO content of 5% by mass or more is used in a content of 10% by volume to 70% by volume has superior flame retardancy and heat resistance, and completed the present invention.

That is, the inventions of the present application are as follows.

[1] A prepreg comprising a glass composition filler having a mean particle diameter of 2.0 μm or less and a CaO content of 5% by mass or more, a glass cloth, and a matrix resin, characterized in that an amount of said glass composition filler to be filled is 10% by volume to 70% by volume relative to the total volume of said glass composition filler and said matrix resin.

[2] The prepreg according to the aforementioned item [1] wherein a specific surface area of said glass composition filler is in the range of 1 m²/g to 20 m³/g.

[3] The prepreg according to the aforementioned item [1] or [2], wherein a mean monofilament diameter of said glass cloth is 7 μm or less.

[4] The prepreg according to any one of the aforementioned items [1] to [3], wherein ah air permeability of said glass cloth is 50 cm³/cm²/sec or less.

[5] The prepreg according to any one of the aforementioned items [1] to [4], wherein a glass composition of said glass composition filler is that of E glass or L glass.

[6] The prepreg according to any one of the aforementioned items [1] to [5], wherein the surface of said glass composition filler has been treated with a silane coupling agent comprising a compound represented by the following general formula (1):

XSi(R)₃₋ₙYₙ (1)

wherein X is an organic functional group, Y is an alkoxy group, n is an integer of 1 to 3, and R is a methyl group, an ethyl group, or a hydroxyl group.

[7] The prepreg according to any one of the aforementioned items [1] to [6], wherein the compound contained in said silane coupling agent is a compound represented by the following general formula (2):

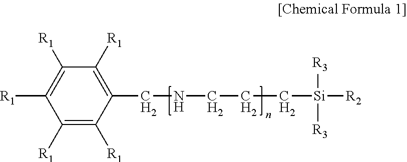

wherein R₁ is each independently a hydrogen atom, a methyl group or an ethyl group, R₂ is an alkoxy group, R₃ is each independently an alkoxy group, a hydroxyl group, a methyl group or an ethyl, group, and n is an integer of 1 to 3.

[8] The prepreg according to any one of the aforementioned items [1] to [7], wherein a content of particles having a particle diameter of 0.5 μm or less in said glass composition filler is 5% or more.

[9] The prepreg according to any one of the aforementioned items [1] to [8], wherein said glass composition filler is obtained by dry grinding.

[10] The prepreg according to the aforementioned item [1], wherein a particle diameter of said glass composition filler is 0.1 μm or more, a content of particles having a particle diameter of 0.5 μm or less is 10% or more, and a specific surface area of said glass composition filler is in the range of 2 m²/g to 20 m³/g.

[11] The prepreg according to the aforementioned item [1] or [10], wherein an air permeability of said glass cloth is 5.0 cm³/cm²/sec or less, and said glass composition filler is one obtained by dry grinding.

### Effect of the Invention

By using the prepreg of the present invention, a laminated sheet superior in flame retardancy and heat resistance which is most suitable for electronics materials application can be provided.

### EMBODIMENTS FOR CARRYING OUT THE INVENTION

Hereinafter, the present invention, will be explained in detail.

### (A) Glass Composition Filler

Raw glass of the glass composition filler to be used in the present invention is a glass which can be used for a laminated sheet for electronic materials application and has a composition of 5% by mass or more of CaO and a low content of alkali metal, and E glass, L glass, and the like are preferable.

An example of the composition of a raw glass for the glass composition filler to be used in the present invention is shown in the following fable 1.

TABLE 1
Unit: % by mass

| | E glass | L glass |
|---|---|---|
| SiO₂ | 55 | 56 |
| Al₂O₃ | 14 | 12.5 |
| CaO | 22 | 5.5 |
| MgO | 0.5 | |
| Na₂O, K2O | 0.5 | |
| B₂O₃ | 7.5 | 26 |
| TiO₂, Fe₂O3 | 0.5 | |

A glass containing 5% by mass or more of CaO has superior processing characteristics such as drilling and laser processing, as well as superior insulation property and heat resistance, and well-balanced laminated sheet characteristics. In addition, since CaO tends to be hydrated, superior flame retardancy can be obtained.

A mean particle diameter of the glass composition filler to be used in the present invention is 2.0 μm or less. When the mean particle diameter is 2 μm or less, said glass composition filler sufficiently penetrates into yarn bundles of glass cloth in a step in which prepreg is obtained by impregnating a glass cloth with a matrix resin varnish and further in a step in which the prepreg is subjected to pressure molding, and a laminated sheet in which said glass composition filler has been uniformly filled can be obtained, and as a result, a laminated sheet having superior flame retardancy can be obtained. Said mean particle diameter is preferably 1.0 μM or less, more preferably 0.7 μm or less, and further more preferably 0.5 μm or less.

A particle diameter distribution of the glass composition filler has the above-described mean particle diameter, moreover has preferably 5% or more, and more preferably 10% or more of cumulative distribution for a particle diameter of 0.5 μm or less. When a glass composition filler has 5% or more of cumulative distribution for a particle diameter of 0.5 μm or less, said glass composition filler tends to penetrate more easily into yarn bundles of glass cloth. In addition, maximum particle diameter is preferably 10 μm less and more preferably 5 μm or less, because when a narrow pitch circuit is formed, the glass composition filler which causes an adverse effect to the circuit formation is kept away from wiring part to enhance insulation reliability. On the other hand, mean particle diameter is preferably 0.1 μm or more, because viscosity increase in varnish blending is prevented.

Particle diameter and particle diameter distribution can be measured by the general laser diffraction/light scattering method. The mean particle diameter means a volume average particle diameter corresponding to a cumulative distribution of 50%, when a cumulative curve is obtained provided that the total volume of sample is 100%, and is generally referred to as D₅₀. “Cumulative distribution for a particle diameter of 0.5 μm or less is 5% or more” means that a particle diameter at the point where a cumulative curve becomes 5% is 0.5 μm or less. Generally, a value referred to as D₅ becomes 0.5 μm or less.

Shape of the glass composition filler may be any of spherical, crushed-like, needle-like, staple fiber-like, and the like. In particular, spherical and crushed-like fillers are most preferable due to superior fluidity in a matrix resin or a resin varnish.

Specific surface area of the glass composition filler is preferably in the range of 1 m²/g to 20 m²/g. When the specific surface area is 1 m²/g or more, flame retardancy can be easily obtained because adsorbed water on the surface of the glass composition, filler also increases. On the other hand, when the specific surface area is 20 m²/g or less, the filler is superior in dispersibility in a matrix resin, and the obtained laminated sheet is superior in heat resistance and flame retardancy.

The surface of the glass composition filler is preferably treated with a silane coupling agent from the viewpoint of dispersibility in a matrix resin. When dispersibility is good, flame retardancy and heat resistance of the laminated sheet are improved. The silane coupling agent includes a silane coupling agent including a compound represented by the following general formula (1):

XSi(R)₃₋ₙTₙ (1)

wherein X is an organic functional group, Y is an alkoxy group, n is an integer of 1 to 3, and R is a methyl group, an ethyl group, or a hydroxyl group. The alkoxy group is preferably the one having 5 or less of carbon atoms, and more preferably the one having one carbon atom, from the viewpoint of reactivity with the glass composition filler.

In particular, the silane coupling agent is preferably the one including a compound represented by the following general formula (2):

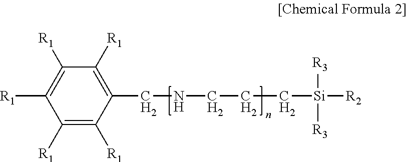

wherein R₁ is each independently a hydrogen atom, a methyl group or an ethyl group, R₂ is an alkoxy group, R₃ is each independently an alkoxy group, a hydroxyl group, a methyl group or an ethyl group, and n is an integer of 1 to 3, from the viewpoint of heat resistance of a laminated sheet.

A compound represented by the above-described general formula (1) includes, specifically, methylbenzyl-aminoethyl-aminopropyltrimethoxysilane, dimethylbenzyl-aminoethyl-aminopropyltrimethoxysilane, benzyl-aminoethyl-aminopropyltrimethoxysilane, benzyl-aminoethyl-aminopropyltriethoxysilane, and the like.

Deposit amount of the silane coupling agent to the glass composition filler is preferably 0.01% by mass to 5.0% by mass, and more preferably 0.1% by mass 1.0% by mass. It is preferably 0.01% by mass or more to obtain the maximum effect of the surface treatment, and preferably 5.0% by mass or less to prevent aggregation of the glass composition filler and improve dispersibility thereof.

It should be noted that an inorganic filler such as silica, alumina, aluminum hydroxide, magnesium hydroxide, talcum, mica, antimony oxide, calcium carbonate, and titanium oxide may be used in combination with the glass composition filler. In particular, when a hydroxide such as aluminum hydroxide and magnesium hydroxide and antimony oxide is used in combination, good flame retardancy can be easily obtained.

As a method for producing the glass filler, a known grinding method such as Henschel mixer, ball mill, bead mill, and jet mill can be used, and any of wet grinding and dry grinding can be used. In this regard, however, dry grinding by airflow or a medium is most preferable to prevent elution of alkali metal and alkaline earth metal and enhance heat resistance of a laminated sheet. Specifically, airflow jet mill, dry ball mill, dry bead mill, and the like are most suitable. Further, after the grinding, the glass filler may be spheroidized by heating at a high temperature.

### (B) Glass Cloth

In the prepreg of the present invention, a glass cloth which is made by weaving a glass yarn is used. The glass cloth is made of warps and wefts. Since there are gaps between warps and also between wefts, there inevitably exists a part with no glass yarn in the glass cloth plane. This part is usually referred to as a basket hole. Size of the basket hole can be evaluated generally by air permeability. An air permeability of the glass cloth to be used in the prepreg of the present invention is preferably 50 cm³/cm²/sec or less. An air permeability of 50 cm³/cm²/sec or less is effective for flame retardancy, because the basket hole is small and a part where no glass cloth exists in a laminated sheet becomes reduced. In addition, the glass composition filler becomes difficult to gather in the basket hole part and easier to penetrate into the glass yarn bundles. Size of the basket hole is preferably 0.005 mm² or less.

Weaving density of the glass cloth is preferably 30 to 200 yarns/inch, and further more preferably 50 to 100 yarns/inch. When, weaving density is 50 yarns/inch or more, air permeability of 50 cm³/cm³/sec or less can be easily obtained.

Mass of the glass cloth is preferably 5 to 400 g/m², and further more preferably 10 to 200 g/m².

As a composition of the glass yarn, any type of E glass, L glass, D glass, S glass, H glass, and the like can be used. In particular, a glass having the same composition to that of the glass composition filler is preferable due to improved uniformity of a substrate.

Glass yarn is preferably the one containing a glass filament having an average monofilament diameter of preferably 2.5 to 9.0 μm and more preferably 4.0 to 7.0 μm, from the viewpoint of workability for drilling and laser processing.

As for weave structure, a plain weave structure is preferable, but a glass cloth having a weave structure such as mat weave, satin weave, and twill weave may be used.

The surface of the glass cloth has been preferably subjected to a surface treatment with a surface treatment agent such as silane coupling agent and titanate coupling agent. The surface treatment agent may be appropriately selected considering reactivity with a matrix resin. For example, when matrix resin is a resin to be obtained by curing epoxy resin, urethane resin, thermosetting polyimide resin, melamine resin, epoxyacrylate, and unsaturated polyester, a silane compound such as γ-(2-aminoethyl)-aminopropyltrimethoxysilane, 3-aminopropyl-triethoxysilane, γ-methacryloxypropyltrimethoxysilane, N-β-(N-vinylbenzylaminoethyl)-γ-aminopropyltrimethoxysilane and hydrochloride salt thereof, N-β-(N-benzylaminoethylaminopropyl)trimethoxysilane and hydrochloride salt thereof, and γ-glycidoxypropyltrimethoxysilane is preferable.

The surface treatment to the glass cloth may foe carried out by treating with the above-described surface treatment agents using a known surface treatment method in a step where a sizing agent required for weaving is removed. In addition, the glass cloth may be subjected to spreading processing using a high-pressure water flow of columnar stream or the like, or ultrasonic wave etc. by high frequency vibration method in water.

### (C) Matrix Resin

Matrix resin to be used in the prepreg of the present invention includes a thermosetting resin or a thermoplastic resin, and combined use of a thermosetting resin and a thermoplastic resin may be employed.

An example of the thermosetting resin includes,
(a) epoxy resin which is cured by reacting a compound having an epoxy group and a compound having a group, which can react with the epoxy group, such as amino group, phenol group, acid anhydride group, hydra side group, isocyanate, group, cyanate group, or hydroxyl group without using a catalyst or by adding a catalyst having a reaction catalytic property such as imidazole compound, tertiary amine compound, urea compound, or phosphorus compound,
(b) radical polymerization type curing resin in which a compound having allyl group, methacryl group, or acryl group is cured using a thermal decomposition type catalyst or a photo decomposition type catalyst as a reaction initiator,
(c) maleimide triazine resin which is cured by reacting a compound having cyanate group and a compound having maleimide group,
(d) thermosetting polyimide resin which is cured by reacting a maleimide compound and an amine compound,
(e) benzoxazine resin which is cured by cross-linking a compound having a benzoxazine ring by heating and polymerizing, and the like.

An example of the thermoplastic resin includes polyphenylene ether, modified polyphenylene ether, polyphenylene sulfide, polysulfone, polyether sulfone, polyarylate, aromatic polyamide, polyether ether ketone, thermoplastic polyimide, insoluble polyimide, polyamide-imide, fluororesin, and the like.

### [Production of Prepreg]

The prepreg of the present invention is composed of the aforementioned glass composition filler, a glass cloth, and a matrix resin.

Total deposit amount of the matrix resin and the glass composition filler to the glass cloth is preferably 30% by mass or more because the prepreg can be easily sheet-molded, and also preferably 9.0% by mass or less because a reinforcing effect of the glass cloth is maximized.

Amount of the glass composition filler to be filled in a matrix resin is preferably 10% by volume to 70% by volume relative to the total volume of said matrix resin and the glass composition filler. When amount of the glass composition filler to be filled is less than 10% by volume, no effect on flame retardancy can be observed. On the contrary, when amount of the glass composition filler to be filled is 70% by volume or more, it becomes difficult to ensure moldability to a laminated sheet.

The prepreg of the present invention can be produced according to a conventional method. For example, a prepreg can be obtained by impregnating a glass cloth with a varnish which is prepared by diluting a surface treated glass composition filler and a matrix resin with an organic solvent, and then partially curing (converting to B-stage) the matrix resin by a method where the glass cloth is heated usually at 100 to 200° C. for 1 to 30 minutes in a dryer, or the like, and at the same time evaporating the organic solvent. After the impregnation, an excess varnish may be removed with a slit or the like to adjust appropriately a thickness.

In order to obtain a sufficient flame retardancy of the prepreg, preferably halogen type flame retardant, phosphorus type flame retardant, or the like is appropriately used. In particular, use of phosphorus type flame retardant is most preferable to minimize environmental load.

As the organic solvent in the above-described varnish, acetone, methyl ethyl ketone, methyl isobutyl ketone, ethylene glycol monomethyl ether, dimethylformamide, dimethylacetoamide, toluene, xylene, tetrahydrofuran (THF) or N-methylpyrolidone (NMP) is preferable, these solvents may be appropriately used as an optional mixture. The total amount of the surface treated glass composition filler and the matrix resin in the varnish is preferably 30% by volume to 90% by volume.

The present invention is explained in more detail by the following Examples, but the present invention is by no means limited by these Examples.

### EXAMPLES

Flame retardancy and heat resistance of a laminated sheet using a prepreg containing the glass composition filler of the present invention, which has a mean particle diameter of 2.0 μm or less and a CaO content of 5% by mass or more were evaluated by the following methods.

### <Measurement Method for Particle Diameter Distribution>

In a state of slurry in which glass composition filler was dispersed in an aqueous solvent, particle diameter distribution of the filler was measured using a laser diffraction instrument (Microtrac MT3300 EXII, manufactured by Nikkiso Co., Ltd.), and average volume particle diameter was calculated.

### <Measurement Method for Specific Surface Area>

Specific surface area of glass composition filler was measured using a specific surface area measurement instrument (BELSOAP28SA, manufactured by Bel Japan, Inc.)

### <Glass Cloth>

Style 1078 glass cloth (produced by Asahi Kasei E-materials Corp., type of glass: E glass, monofilament diameter: 5 μm, number of filament constituting a yarn: 200 filaments, weave structure: plain weave, weaving density: (warp) 54 yarns/inch, (weft) 54 yarns/inch, air permeability: 9 cm³/m²/sec, mass: 47.0 g/m²) (hereinafter, referred to as “glass cloth A”) and Style 1080 glass cloth (produced by Asahi Kasei E-materials Corp., type of glass: E glass, monofilament diameter: 5 μm, number of filament constituting a yarn: 200 filaments, weave structure: plain weave, weaving density: (warp) 60 yarns/inch, (weft) 47 yarns/inch, air permeability: 65 cm³/cm²/sec, mass: 48.0 g/m²) (hereinafter, referred to as “glass cloth B”), which had been treated with N-(vinylbenzyl)-β-aminoethyl-γ-aminopropyltrimethoxysilane hydrochloride (SZ6032, produced by Dow Corning Toray Co., Ltd.) were used.

### <Matrix Resin Varnish Composition>

A matrix resin varnish (hereinafter, referred to as “matrix resin varnish A”) was obtained by blending bisphenol A novolac type epoxy resin (Epicoat 157S70B75, produced by Japan Epoxy Resin Co., Ltd.) (48.5 parts by mass), bisphenol A type epoxy resin (Epicoat 1001B80, produced by Japan Epoxy Resin. Co., Ltd.) (10 parts by mass), bisphenol A novolac (Epicure YLH129B65, produced by Japan Epoxy Resin Co., Ltd.) (30 parts by mass), cyclophosphazene (SPB100, produced by Otsuka Chemical Co., Ltd.) (11.5 parts by mass), and 2-ethyl-4-methylimidazole (0.1 part by mass).

### <Preparation Method for Laminated Sheet>

Four sheets of prepregs were stacked and copper foils each having a thickness of 12 μm were further stacked on the top and under the bottom of the prepregs. These prepregs were heated and pressed at 195° C. and 40 kg/cm² to obtain a laminated sheet.

### <Evaluation Method for Flame Retardancy of Laminated Sheet>

A laminated sheet was cut to a size of 13 mm×130 mm to prepare 5 test pieces. After contacting each test piece with flame using a gas burner, a time until burning of the laminated sheet stops was measured. When burning did not stop and the test piece was completely burnt out, the sample was scored as “completely burnt”. Flame retardancy was judged according to UL standard.

### <Evaluation Method for Solder Heat Resistance of Laminated Sheet>

Firstly, a laminated sheet having a size of 500 mm×500 mm was placed under the atmosphere of 20° C., 60% RH for 24 hours, subsequently exposed to the atmosphere of 121° C., 100% RH for 1 to 24 hours. After that, moisture on the surface was removed, and then the laminated sheet was dipped in a solder bath, at 288° C. and taken out, and degree of swelling was evaluated by visual inspection. Number of sample was 5 pieces for each testing time. In the Table 3 below, evaluation results are shown by “o” for swelling less than 5 mm and by “x” for swelling of 5 mm or more.

### Example 1

An E glass composition filler having a mean particle diameter of 0.5 μm and a cumulative distribution for a particle diameter of 0.5 μm or leas of 32% (specific surface area: 12 m²/g, wet ground product), which had been treated with methyltrimethoxysilane was dispersed in matrix resin varnish A and ethylene glycol monomethyl ether to obtain a matrix resin varnish in which a total solid content of the matrix resin and the glass composition filler was adjusted to be 70% by mass, and a concentration of the glass composition filler in the solid content was also adjusted to be 30% by volume. Glass cloth A was impregnated with said matrix resin varnish, and dried at 160° C. for 1 minute to obtain a prepreg.

### Example 2

An E glass composition filler having a mean particle diameter of 0.7 μm and a cumulative distribution for a particle diameter of 0.5 μm or less of 15% (specific surface area: 10 m²/g, wet ground product), which had been treated with aminopropyltrimethoxysilane, was dispersed in matrix resin varnish A and ethylene glycol monomethyl ether to obtain a matrix resin varnish in which a total solid content of the matrix resin and the glass composition filler was adjusted to be 70% by mass, and a concentration of the glass composition filler in the solid content was also adjusted to be 30% by volume. Glass cloth A was impregnated with said matrix resin varnish, and dried at 16° C. for 1 minute to obtain a prepreg.

### Example 3

An E glass composition filler having a mean particle diameter of 0.7 μm and a cumulative distribution for a particle diameter of 0.5 μm or less of 15% (specific surface area: 10 m²/g, wet ground product), which had been treated with aminopropyltrimethoxysilane, was dispersed in matrix resin varnish A and ethylene glycol monomethyl ether to obtain a matrix resin varnish in which a total solid content of the matrix resin and the glass composition filler was adjusted to be 70% by mass, and a concentration of the glass composition filler in the solid content was also adjusted to be 30% by volume. Glass cloth A was impregnated with said matrix resin varnish, and dried at 160° C. for 1 minute to obtain a prepreg.

### Example 4

An E glass composition filler having a mean particle diameter of 1.8 μm and a cumulative distribution for a particle, diameter of 0.5 μm or less of 5% (specific surface area: 3 m²/g, wet ground product), which had been treated with aminopropyltrimethoxysilane, was dispersed in matrix resin varnish A and ethylene glycol monomethyl ether to obtain a matrix resin varnish in which a total solid content of the matrix resin and the glass composition filler was adjusted to be 70% by mass, and a concentration of the glass composition filler in the solid content was also adjusted to be 30% by volume. Glass cloth A was impregnated with said matrix resin varnish, and dried at 160° C. for 1 minute to obtain a prepreg.

### Example 5

An E glass composition filler having a mean particle diameter of 0.2 μm and a cumulative distribution for a particle diameter of 0.5 μm or less of 80% (specific surface area: 21 m²/g, wet ground product), which had been treated with aminopropyltrimethoxysilane, was dispersed in matrix resin varnish A and ethylene glycol monomethyl ether to obtain a matrix resin varnish in which a total solid content of the matrix resin and the glass composition filler was adjusted to be 70% by mass, and a concentration of the glass composition filler in the solid content was also adjusted to be 30% by volume. Glass cloth A was impregnated with said matrix resin varnish, and dried at 160° C. for 1 minute to obtain a prepreg.

### Example 6

An E glass composition filler having a mean particle diameter of 1.8 μm and a cumulative distribution for a particle diameter of 0.5 μm or less of 5% (specific surface area: 2 m²/g, wet ground product), which had been treated with aminopropyltrimethoxysilane, was dispersed in matrix resin varnish A and ethylene glycol monomethyl ether to obtain a matrix resin varnish in which a total solid content of the matrix resin and the glass composition filler was adjusted to be 70% by mass, and a concentration of the glass composition filler in the solid content was also adjusted to be 30% by volume. Glass cloth A was impregnated with said matrix resin varnish, and dried at 160° C. for 1 minute to obtain a prepreg.

### Example 7

An E glass composition filler having a mean particle diameter of 1.8 μm and a cumulative distribution for a particle diameter of 0.5 μm or less of 3% (specific surface area: 2 m²/g, wet ground product), which had been treated with aminopropyltrimethoxysilane, was dispersed in matrix resin varnish A and ethylene, glycol monomethyl ether to obtain a matrix resin varnish in which a total solid content of the matrix resin and the glass composition filler was adjusted to be 70% by mass, and a concentration of the glass composition filler in the solid content was also adjusted to be 30% by volume. Glass cloth A was impregnated with said matrix resin varnish, and dried at 160° C. for 1 minute to obtain a prepreg.

### Comparative Example 1

An E glass composition filler having a mean particle diameter of 2.6 μm and a cumulative distribution for a particle diameter of 0.5 μm or less of 0.5% (specific surface area; 3 m²/g), which had been treated with aminopropyltrimethoxysilane, was dispersed in matrix resin varnish A and ethylene glycol monomethyl ether to obtain a matrix resin varnish in which a total solid content of the matrix resin and the glass composition filler was adjusted to be 70% by mass, and a concentration of the glass composition filler in the solid content was also adjusted to be 30% by volume. Glass cloth A was impregnated with said matrix resin varnish, and dried at 160° C. for 1 minute to obtain a prepreg.

### Comparative Example 2

A non-treated silica filler having a mean particle diameter of 0.5 μm and a cumulative distribution for a particle diameter of 0.5 μm or less of 30% (specific surface area: 9 m²/g) was dispersed in matrix resin varnish A and ethylene glycol monomethyl ether to obtain a matrix resin varnish in which a total solid content of the matrix resin and the silica filler was adjusted to be 70% by mass, and a concentration of the silica filler in the solid content was also adjusted to be 30% by volume. Glass cloth A was impregnated with said matrix resin varnish, and dried at 160° C. for 1 minute to obtain a prepreg.

### Comparative Example 3

A non-treated aluminum hydroxide filler having a mean particle diameter of 2.1 μm and a cumulative distribution for a particle diameter of 0.5 μm or less of 1% (specific surface area: 4 m²/g) was dispersed in matrix resin varnish A and ethylene glycol monomethyl ether to obtain a matrix resin varnish in which a total solid content of the matrix resin and the aluminum hydroxide filler was adjusted to be 70% by mass, and a concentration of the aluminum hydroxide filler in the solid content was also adjusted to be 30% by volume. Glass cloth A was impregnated with said matrix resin varnish, and dried at 160° C. for 1 minute to obtain a prepreg.

Evaluation results on flame retardancy of laminated sheets prepared from the prepregs obtained in the above-described Examples and Comparative Examples are shown in Table 2, and evaluation results on heat resistances are shown in Table 3.

TABLE 2

| | Flaming time | Total flaming | Comprehensive |
|---|---|---|---|
| | (sec) | time (sec) | judgment |
| Example 1 | 6 | 32 | corresponds to |
| | 8 | | UL 94 V-0 |
| | 6 | | |
| | 6 | | |
| | 6 | | |
| Example 2 | 5 | 35 | corresponds to |
| | 8 | | UL 94 V-0 |
| | 5 | | |
| | 8 | | |
| | 9 | | |
| Example 3 | 5 | 45 | corresponds to |
| | 11 | | UL 94 V-1 |
| | 15 | | |
| | 9 | | |
| | 5 | | |
| Example 4 | 7 | 38 | corresponds to |
| | 8 | | UL 94 V-0 |
| | 5 | | |
| | 9 | | |
| | 8 | | |
| Example 5 | 7 | 45 | corresponds to |
| | 10 | | UL 94 V-1 |
| | 13 | | |
| | 8 | | |
| | 7 | | |
| Example 6 | 5 | 28 | corresponds to |
| | 6 | | UL 94 V-0 |
| | 5 | | |
| | 6 | | |
| | 6 | | |
| Example 7 | 13 | 48 | corresponds to |
| | 8 | | UL 94 V-1 |
| | 9 | | |
| | 10 | | |
| | 8 | | |
| Comparative | 6 | — | not conformed |
| Example 1 | completely burnt | | |
| | completely burnt | | |
| | 7 | | |
| | completely burnt | | |
| Comparative | completely burnt | — | not conformed |
| Example 2 | 10 | | |
| | completely burnt | | |
| | 11 | | |
| | completely burnt | | |
| Comparative | 6 | 28 | corresponds to |
| Example 3 | 5 | | UL 94 V-0 |
| | 6 | | |
| | 6 | | |
| | 5 | | |

TABLE 3

| | Water absorption | | Water absorption | | Water absorption | |
|---|---|---|---|---|---|---|
| | 6 hours | | 9 hours | | 15 hours | |
| | Water | Degree | Water | Degree | Water | Degree |
| | absorption | of swelling at | absorption | of swelling at | absorption | of swelling at |
| | rate | 288° C. | rate | 288° C. | rate | 288° C. |
| Example 1 | 0.68% | ∘∘∘∘ | 0.69% | ∘∘∘∘ | 0.71% | ∘∘∘∘ |
| Example 2 | 0.67% | ∘∘∘∘ | 0.69% | ∘∘∘∘ | 0.69% | ∘∘∘∘ |
| Example 3 | 0.67% | ∘∘∘∘ | 0.68% | ∘∘∘∘ | 0.70% | ∘∘∘∘ |
| Example 4 | 0.67% | ∘∘∘∘ | 0.68% | ∘∘∘∘ | 0.70% | ∘∘∘∘ |
| Example 5 | 0.68% | ∘∘∘∘ | 0.70% | ∘∘∘∘ | 0.72% | ∘∘∘∘ |
| Example 6 | 0.65% | ∘∘∘∘ | 0.65% | ∘∘∘∘ | 0.66% | ∘∘∘∘ |
| Example 7 | 0.67% | ∘∘∘∘ | 0.67% | ∘∘∘∘ | 0.69% | ∘∘∘∘ |
| Comparative | 0.68% | ∘∘∘∘ | 0.68% | ∘∘∘∘ | 0.69% | ∘∘∘∘ |
| Example 1 | | | | | | |
| Comparative | 0.73% | ∘∘∘∘ | 0.78% | ∘∘∘∘ | 0.74% | ∘∘∘x |
| Example 2 | | | | | | |
| Comparative | 0.80% | ∘∘∘∘ | 0.85% | ∘∘xx | 0.83% | ∘xxx |
| Example 3 | | | | | | |

It can be understood that all prepregs of Examples 1 to 7 are superior in flame retardancy and heat resistance compared with those in Comparative Examples 1 to 3.

### INDUSTRIAL APPLICABILITY

The prepreg of the present invention can be suitably utilized for electronics materials application.

1. A prepreg comprising a glass composition filler having a mean particle diameter of 2.0 μm or less and a CaO content of 0.5% by mass or more, a glass cloth, and a matrix resin, characterized in that an amount of said glass composition filler to be filled is 10% by volume to 70% by volume relative to the total volume of said glass composition filler and said matrix resin.

2. The prepreg according to claim 1, wherein a Specific surface area of said glass composition filler is in the range of 1 m²/g to 20 m²/g.

3. The prepreg according to claim 1 or 2, wherein a mean monofilament diameter of said glass cloth is 7 μm or less.

4. The prepreg according to claim 1 or 2, wherein van air permeability of said glass cloth is 5.0 cm³/cm²/sec or less.

5. The prepreg according to claim 1 or 2, wherein a glass composition of said glass composition filler is that of E glass or L glass.

6. The prepreg according to claim 1 or 2, wherein the surface of said glass composition filler is treated with a silane coupling agent comprising a compound represented by the following general formula (1):
XSi(R)₃₋ₙYₙ (1)
wherein X is an organic functional group, Y is an alkoxy group, n is an integer of 1 to 3, and R is a methyl group, an ethyl group, or a hydroxyl group.

7. The prepreg according to claim 6, wherein the compound contained in said silane coupling agent is a compound, represented by the following general formula (2): 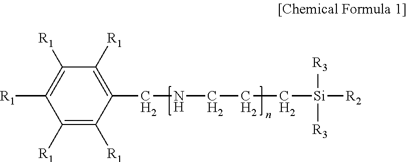
wherein R₁ is each independently a hydrogen atom, a methyl group or an ethyl group, R₁ is an alkoxy group, R₃ is each independently an alkoxy group, a hydroxyl group, a methyl group or an ethyl group, and n is an integer of 1 to 3.

8. The prepreg according to claim 1 or 2, wherein a content of particles having a particle diameter of 0.5 μm or less in said glass composition filler is 5% or more.

9. The prepreg according to claim 1 or 2, wherein said glass composition filler is obtained by dry grinding.

10. The prepreg according to claim 1, wherein a particle diameter of said glass composition filler is 0.1 μm or more, a content of particles having a particle diameter of 0.5 μm or less is 10% or more, and a specific surface area of said glass composition filler is in the range of 2 m²/g to 20 m²/g.

11. The prepreg according to claim 1 or 10, wherein an air permeability of said glass cloth is 50 cm³/cm²/sec or less, and said glass composition filler is obtained by dry grinding.
